(19) United States
(12) Patent Application Publication
(10) Pub. No.: US 2026/0344622 A1
(43) Pub. Date: Nov. 5, 2026

(54) HARNESS DEVICE FOR ANIMAL

(71) Applicant: HABLE HOUND INC, Dover, DE (US)

(72) Inventors: Xiaoxuan Chen, Shenzhen (CN); Jian Huang, Shenzhen (CN); Yanbo Zheng, Shenzhen (CN)

(21) Appl. No.: 19/728,232

(22) Filed: Jul. 1, 2026

(30) Foreign Application Priority Data
May 7, 2026 (CN) 202610621353.6

(51) Int. Cl. A01K 27/00

(52) U.S. Cl. CPC A01K 27/002; A01K 27/009

(57) ABSTRACT

A harness device for an animal includes a flexible harness base, at least two functional assemblies, a flexible connecting portion, and a solar cell. The flexible harness base has a back portion, a chest portion, and front and rear side portions. The rear side portions, the front side portions, the back portion, and the chest portion together define side openings. The rear side portions, the back portion, and the chest portion together define a rear opening. The front side portions, the back portion, and the chest portion together define a front opening. The flexible connecting portion allows the adjacent functional assemblies to undergo relative angular change in a worn state to adapt to curvature changes of the animal's body surface. The solar cell is disposed on the functional assembly and includes a gallium arsenide solar cell. The harness device offers improved light-receiving conditions, enhanced endurance, and improved wearing comfort.

### CROSS REFERENCE TO RELATED APPLICATIONS

The present application claims the benefit of Chinese Patent Application No. 202610621353.6 filed on May 7, 2026, the contents of which are incorporated herein by reference in their entirety.

### FIELD OF THE INVENTION

The present application relates to the technical field of wearable electronic devices for animals, and more particularly to a harness device for an animal that utilizes a gallium arsenide solar cell to power functional assemblies.

### BACKGROUND OF THE INVENTION

Wearable electronic devices for animals are well known in the art and typically integrate various functionalities such as positioning, communication, illumination, or training. However, during activities such as running, jumping, or rolling, such devices are prone to posture inversion or rotation, which results in instability in the orientation of the upper surface of the wearable electronic device.

In cases where a wearable electronic device for animals incorporates photovoltaic power supply and satellite positioning reception, the unstable posture of the device causes fluctuations in photovoltaic light-receiving conditions and reduces the average effective light-receiving area. Moreover, because the available surface area on the device for photovoltaic arrangement in the worn state is limited, and the weight and volume of the device are also constrained, simply employing photovoltaic devices with low unit-area output power or merely enlarging the battery footprint cannot adequately satisfy the device's energy supply requirements. Consequently, existing wearable electronic devices for animals suffer from poor stability in energy harvesting and inadequate endurance.

Furthermore, in conventional wearable electronic devices for animals, a monolithic housing is typically employed, or multiple functional components are centrally mounted on a unitary base structure or main housing, which is then connected to a wearing strap. As a result, during animal movements such as running, jumping, turning, and pitching, the curvature and deformation of the animal's torso surface are significant. A centralized or large-volume rigid structure tends to cause localized pressure on the animal and poor conformance to the animal's body contour, leading to reduced wearing comfort and stress concentration.

Accordingly, there is a need for a harness device for an animal that overcomes one or more of the above-mentioned disadvantages.

### SUMMARY OF THE INVENTION

The present disclosure aims to provide a harness device for an animal that offers improved light-receiving conditions, enhanced endurance, and improved wearing comfort.

To achieve the above objective, the harness device for an animal includes a flexible harness base configured to be worn on a torso surface of the animal, at least two functional assemblies, a flexible connecting portion disposed between adjacent functional assemblies, and a solar cell for powering a circuit assembly disposed within each functional assembly. The flexible harness base has a back portion that faces upward in a worn state, a chest portion that faces downward in the worn state, and front and rear side portions each connecting the chest portion and the back portion. The rear side portions, the front side portions, the back portion, and the chest portion together define side openings through which the animal's front legs extend out of the flexible harness base. The rear side portions, the back portion, and the chest portion together define a rear opening through which the animal's torso extends rearwardly out of the flexible harness base. The front side portions, the back portion, and the chest portion together define a front opening through which the animal's torso extends forwardly out of the flexible harness base. The functional assemblies are mounted on the back portion and face an outer side of the back portion, and each functional assembly has a circuit assembly disposed therein. The flexible connecting portion allows the adjacent functional assemblies to undergo relative angular change in a worn state to adapt to curvature changes of the animal's body surface. The solar cell is disposed on a surface of each functional assembly facing away from the back portion, and the solar cell includes a gallium arsenide solar cell.

Compared with the prior art, the flexible harness base according to the present disclosure has the back portion that faces upward in the worn state, the chest portion that faces downward in the worn state, and the front and rear side portions each connecting the chest portion and the back portion, and the rear side portions, the front side portions, the back portion, and the chest portion together define the side openings, the rear side portions, the back portion, and the chest portion together define the rear opening, and the front side portions, the back portion, and the chest portion together define the front opening, thus the functional assemblies and the solar cells thereon are maintained in an upward-facing orientation in the worn state, thereby providing stable light-receiving conditions, increasing the effective operating time ratio of the solar cells, and enhancing the availability and practical value of solar energy supply in the worn state. Furthermore, the solar cell includes the gallium arsenide solar cell, thus higher unit-area output power is provided within the limited light-receiving area, allowing the harvested energy to more effectively participate in the energy supply system of the harness device, thereby improving the endurance of the device. In addition, by virtue of the flexible connecting portion, the adjacent functional assemblies are allowed to undergo angular change in the worn state to adapt to curvature changes of the animal's body surface, thereby providing good wearing comfort and avoiding stress concentration.

In a preferred embodiment, the solar cell further includes a perovskite solar cell stacked on the gallium arsenide solar cell.

In a preferred embodiment, the gallium arsenide solar cell is a multi-junction gallium arsenide solar cell.

In a preferred embodiment, the flexible harness base further includes an opening/closing structure for separating or joining at least one of the front side portions and the rear side portions, the opening/closing structure being a snap fastener or a hook-and-loop fastener.

In a preferred embodiment, the flexible connecting portion is an elastomeric connecting member, a flexible sheet-like connecting member, a corrugated connecting member, a serpentine connecting member, or a fabric composite connecting member, and the flexible connecting portion allows the adjacent functional assemblies to rotate relative to each other.

In a preferred embodiment, an end of each functional assembly is provided with an end connection interface structure for cooperating with the flexible connecting portion.

In a preferred embodiment, the end connection interface structure is connected to the flexible connecting portion by overmolding, snap-fitting, or interlocking.

In a preferred embodiment, each functional assembly defines a communication channel therein, and the flexible connecting portion defines an electrical connection channel therein aligned and communicating with the communication channel.

In a preferred embodiment, a conductive member is disposed within the electrical connection channel for electrically connecting the circuit assemblies of the adjacent functional assemblies.

In a preferred embodiment, the conductive member is an electrical wire or a flexible printed circuit board.

In a preferred embodiment, the end connection interface structure includes an annular boss disposed around the communication channel and overmolded with the flexible connecting portion.

In a preferred embodiment, a sidewall of the annular boss defines an annular groove extending circumferentially around the annular boss and overmolded with the flexible connecting portion.

In a preferred embodiment, at least one of the functional assemblies further has an energy storage unit disposed therein for storing electricity supplied by the solar cell.

In a preferred embodiment, the circuit assembly includes a positioning module and/or a wireless communication module.

In a preferred embodiment, the wireless communication module includes at least one of cellular communication, Bluetooth, and Wi-Fi communication.

In a preferred embodiment, the harness device further includes a flexible connecting strap disposed between the back portion and the functional assemblies. The back portion defines a first through hole and a second through hole; a first end of the flexible connecting strap passes through the first through hole and is attached to an inner side of the back portion, and a second end of the flexible connecting strap passes through the second through hole and is attached to the inner side of the back portion; and each functional assembly is provided with a loop-around structure around which a portion of the flexible connecting strap between the first and second ends loops to mount each functional assembly onto the back portion.

In a preferred embodiment, each functional assembly further defines a guide groove facing the back portion for guiding the functional assembly to slide along the flexible connecting strap during angular change, the portion of the flexible connecting strap between the first and second ends being received in the guide groove; and the loop-around structure extends across the guide groove and is located at an end of the functional assembly remote from the flexible connecting portion.

In a preferred embodiment, in the adjacent functional assemblies, each functional assembly protrudes toward the back portion relative to the corresponding flexible connecting portion such that the adjacent functional assemblies and the corresponding flexible connecting portion together define a recess, the recess facing the portion of the flexible connecting strap between the first and second ends.

In a preferred embodiment, at least one of the first end and the second end of the flexible connecting strap is detachably attached to the inner side of the back portion via a hook-and-loop fastener or a snap fastener.

### BRIEF DESCRIPTION OF THE DRAWINGS

The accompanying drawings facilitate an understanding of the various embodiments of this invention. In such drawings:

FIG. 1 is a perspective view of the harness device for an animal according to the present disclosure in a worn state;

FIG. 2 is a perspective view of the harness device for an animal of FIG. 1 from another angle;

FIG. 3 is a plan view of the harness device for an animal of FIG. 1 viewed from right to left;

FIG. 4 is a plan view of the harness device for an animal of FIG. 1 viewed from top to bottom;

FIG. 5 is a cross-sectional view taken along line A-A of FIG. 4;

FIG. 6 is an enlarged partial cross-sectional view of FIG. 5;

FIG. 7 is an enlarged view of portion B of FIG. 6;

FIG. 8 is an enlarged view of portion C of FIG. 6;

FIG. 9 is a perspective view of FIG. 2 with the harness base hidden;

FIG. 10 is a view of FIG. 9 with the flexible connecting strap removed from the functional assemblies; and

FIG. 11 is an internal view of the solar cell of the harness device for an animal according to the present disclosure.

### DETAILED DESCRIPTION OF ILLUSTRATED EMBODIMENTS

To describe the technical content and structural features of the present disclosure in detail, further explanation is provided below with reference to the accompanying drawings and the embodiments.

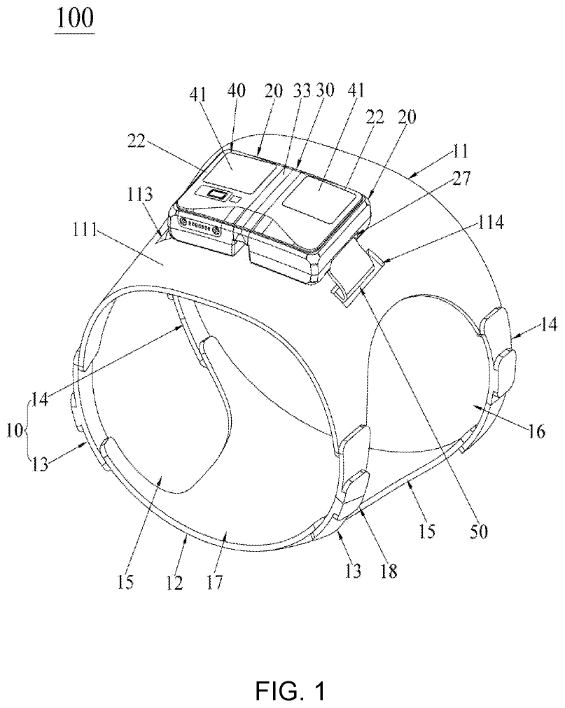

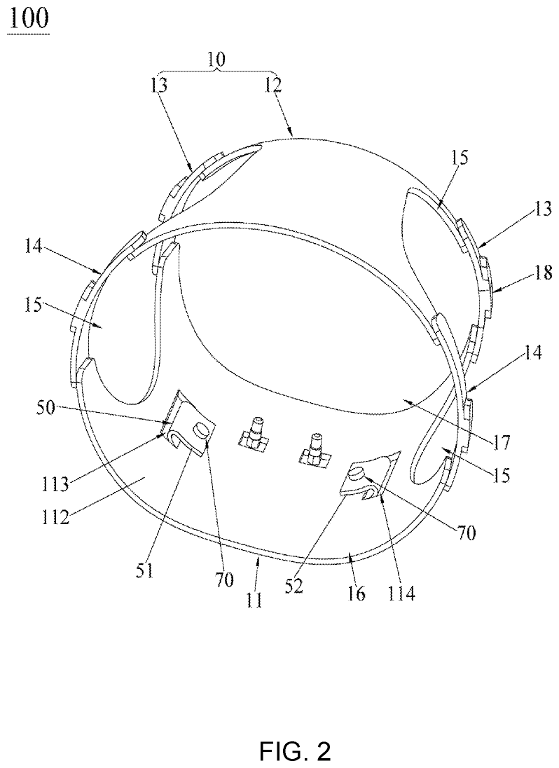

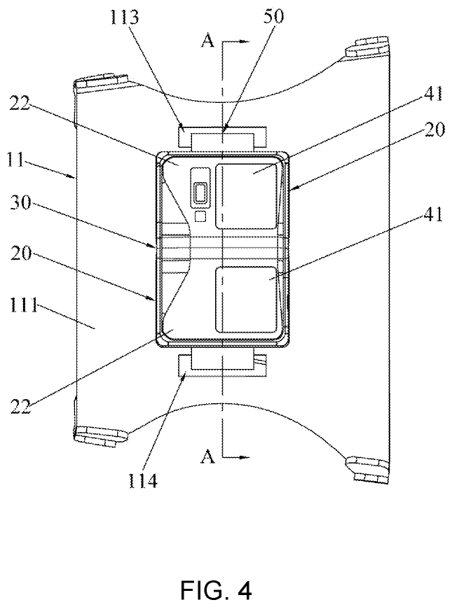

Referring to FIGS. 1 and 2, the harness device 100 for an animal according to the present disclosure is configured to be worn on a torso surface of an animal in a surrounding and conforming manner so as to minimize undesirable rotation of the harness device 100 relative to the torso surface in the circumferential direction. With further reference to FIGS. 4 to 6, the harness device 100 includes a flexible harness base 10 configured to be worn in conformity with a torso surface of an animal, two functional assemblies 20 spaced apart, a flexible connecting portion 30 disposed between adjacent functional assemblies 20, and a solar cell 40 for powering a circuit assembly 21 described below.

As shown in FIG. 1, the flexible harness base 10 has a back portion 11 that faces upward in the worn state (i.e., when the flexible harness base 10 is worn on the animal's torso surface), a chest portion 12 that faces downward in the worn state, and front side portions 13 and rear side portions 14 each connecting the chest portion 12 and the back portion 11. The rear side portions 14, the front side portions 13, the back portion 11, and the chest portion 12 together define side openings 15 through which the animal's front legs extend out of the flexible harness base 10. As shown in FIG. 1, the front side portions 13 and the rear side portions 14 are arranged in a left-right opposing configuration, thus providing two side openings 15—one left side opening and one right side opening—so that the animal's left and right front legs can extend through the respective side openings 15. The rear side portions 14, the back portion 11, and the chest portion 12 together define a rear opening 16 through which the animal's torso extends rearwardly out of the flexible harness base 10. The front side portions 13, the back portion 11, and the chest portion 12 together define a front opening 17 through which the animal's torso extends forwardly out of the flexible harness base 10. Thus, in the worn state of the flexible harness base 10, the animal's front legs extending through the side openings 15 prevent the flexible harness base 10 from undesirably rotating about the animal's torso surface in the circumferential direction, so that the back portion 11 remains stably facing upward and the chest portion 12 remains stably facing downward, thereby creating favorable conditions for improving light-receiving conditions.

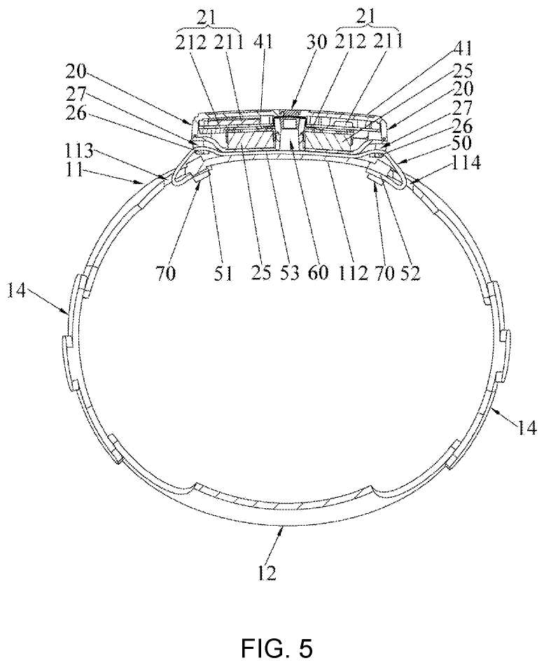

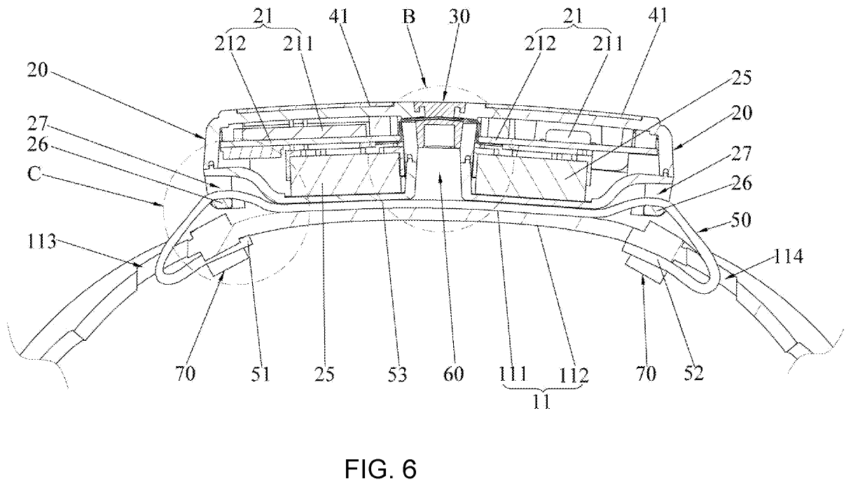

The functional assemblies 20 are mounted on the back portion 11 and face an outer side 111 of the back portion 11, such that the functional assemblies 20 face upward in the worn state. Each functional assembly 20 has a circuit assembly 21 disposed therein. As shown in FIGS. 5 and 6, the circuit assembly 21 includes a satellite positioning module 211. In combination with the upward arrangement of the functional assemblies 20 in the worn state, the stability of satellite signal reception conditions for the satellite positioning module 211 is effectively improved. It should be noted that although the circuit assembly 21 is described as including a satellite positioning module 211, the circuit assembly 21 may also include a wireless communication module, or both a satellite positioning module 211 and a wireless communication module, so the illustrated configuration is not limiting. The wireless communication module may include at least one of cellular communication, Bluetooth, and Wi-Fi communication, and the satellite positioning module 211 is merely one embodiment of a positioning module; that is, the positioning module may be other types of positioning modules in addition to the satellite positioning module 211.

Furthermore, the flexible connecting portion 30 allows adjacent functional assemblies 20 to undergo relative angular change in the worn state. For example, in FIG. 6, the flexible connecting portion 30 allows adjacent functional assemblies 20 to move toward each other (decreasing the angle between them) or away from each other (increasing the angle between them) to adapt to curvature changes of the animal's body surface. As an exemplary configuration, the flexible connecting portion 30 may be an elastomeric connecting member, a flexible sheet-like connecting member, a corrugated connecting member, a serpentine connecting member, or a fabric composite connecting member. By virtue of bending and automatic resetting of the flexible connecting portion 30, adjacent functional assemblies 20 are allowed to rotate relative to each other, thereby achieving angular change.

The solar cell 40 (see FIG. 1) is disposed on a surface 22 of each functional assembly 20, and this surface 22 faces away from the back portion 11, so that the solar cell 40 remains in an upward-facing (skyward) orientation in the worn state, thereby ensuring stable light-receiving conditions for the solar cell 40. In addition, the solar cell 40 includes a gallium arsenide solar cell 41, which provides high unit-area output power under the limited light-receiving area and weight constraints of the harness device 100, allowing the harvested solar energy to participate in the energy supply system of the harness device 100 and thereby improving the endurance of the device. Specifically, as an exemplary configuration, the gallium arsenide solar cell 41 is a multi-junction gallium arsenide solar cell, such as a dual-junction, triple-junction, or more-junction gallium arsenide multi-junction cell structure, to further improve unit-area output power, making it more suitable for applications with limited light-receiving area and weight constraints. Moreover, the multi-junction gallium arsenide solar cell includes at least two sub-cell junction layers having different bandgaps to improve spectral utilization efficiency and further increase unit-area output power. Further details are provided below.

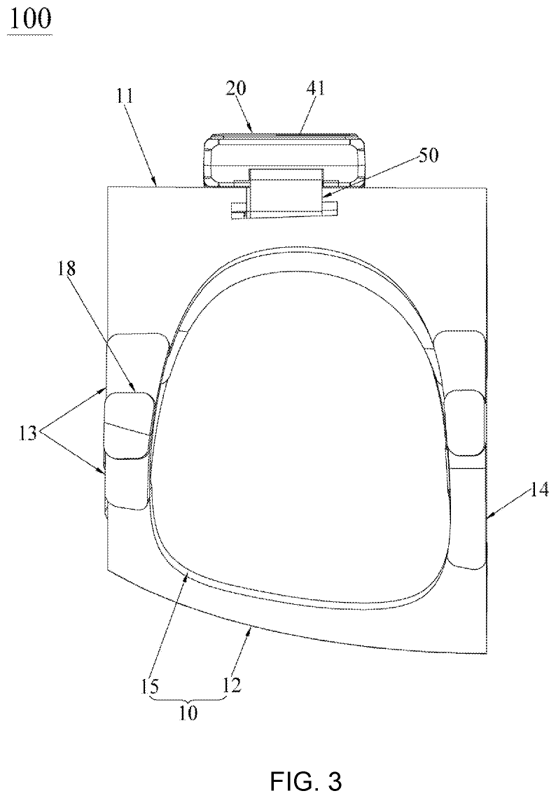

As shown in FIGS. 1 to 3, in an exemplary configuration, the flexible harness base 10 further includes an opening/closing structure 18 for separating or joining the front side portions 13. The opening/closing structure 18 may be, but is not limited to, a snap fastener or a hook-and-loop fastener, improving the convenience of wearing the harness device 100. Although FIGS. 1 and 3 show the opening/closing structure 18 separating or joining the left front side portion 13, the opening/closing structure 18 may also separate or join the right front side portion 13, or may separate or join the left and/or right rear side portions 14. Thus, the illustrated configuration is not limiting.

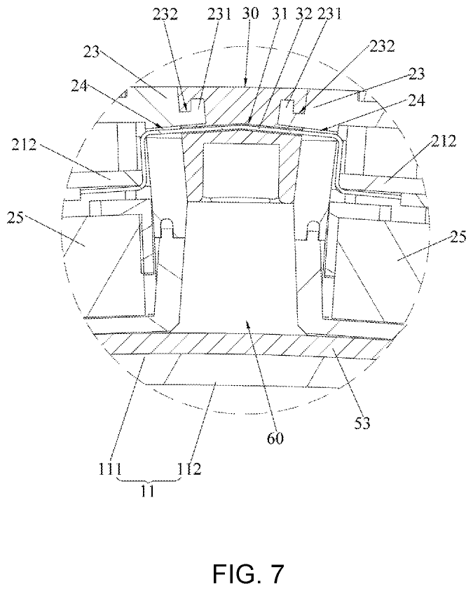

As shown in FIG. 7, in an exemplary configuration, an end of each functional assembly 20 is provided with an end connection interface structure 23 for cooperating with the flexible connecting portion 30. The end connection interface structure 23 may be overmolded with the flexible connecting portion 30, thereby ensuring reliable connection and sealing between the functional assembly 20 and the flexible connecting portion 30, and improving waterproof, dustproof, and impact resistance capabilities. Alternatively, the end connection interface structure 23 may be snap-fitted or interlocked with the flexible connecting portion 30.

As shown in FIG. 7, in an exemplary configuration, each functional assembly 20 defines a communication channel 24 therein, and the flexible connecting portion 30 defines an electrical connection channel 31 therein aligned and communicating with the communication channel 24. A conductive member 32 is disposed within the electrical connection channel 31 for electrically connecting the circuit assemblies 21 of adjacent functional assemblies 20. As an exemplary configuration, the conductive member 32 may be an electrical wire or a flexible printed circuit board, thereby meeting the requirements for power and signal transmission between the circuit assemblies 21 of adjacent functional assemblies 20 and improving the reliability and consistency of wiring and electrical connection between the functional assemblies 20.

As shown in FIG. 7, in an exemplary configuration, the end connection interface structure 23 includes an annular boss 231 disposed around the communication channel 24 and overmolded with the flexible connecting portion 30. The annular boss 231 increases the overmolding area between the functional assembly 20 and the flexible connecting portion 30. Optionally, a sidewall of the annular boss 231 defines an annular groove 232 extending circumferentially around the annular boss 231 and overmolded with the flexible connecting portion 30, further increasing the overmolding area.

As shown in FIGS. 6 and 7, in an exemplary configuration, each functional assembly 20 further has an energy storage unit 25 disposed therein for storing electricity supplied by the solar cell 40, thereby further improving the endurance of the harness device 100. Alternatively, only some of the functional assemblies 20 may have an energy storage unit 25 disposed therein, so the illustrated configuration is not limiting. The energy storage unit 25 may be, but is not limited to, a secondary battery. It is contemplated that the annular boss 231 and the annular groove 232 may be configured with either circumferentially open ends or circumferentially closed (continuous) configurations. Thus, the illustrated configuration is not limiting.

With reference to FIGS. 5 to 10, in an exemplary configuration, the harness device 100 further includes a flexible connecting strap 50 disposed between the back portion 11 and the functional assemblies 20. The back portion 11 defines a first through hole 113 and a second through hole 114. As shown in FIG. 1, the first through hole 113 and the second through hole 114 are laterally spaced apart, although other configurations are possible. A first end 51 of the flexible connecting strap 50 passes through the first through hole 113 and is attached to an inner side 112 of the back portion 11, and a second end 52 of the flexible connecting strap 50 passes through the second through hole 114 and is attached to the inner side 112 of the back portion 11. Each functional assembly 20 is provided with a loop-around structure 26 around which a portion 53 of the flexible connecting strap 50 between the first end 51 and the second end 52 loops to mount each functional assembly 20 onto the back portion 11. This configuration allows adjacent functional assemblies 20 to slide along the flexible connecting strap 50 while adaptively undergoing relative angular change in response to curvature changes of the animal's body surface. Thus, whether the adjacent functional assemblies 20 approach each other (arching) or move away from each other (flattening), they do not cause the back portion 11 to arch or flatten, thereby ensuring that the flexible harness base 10 remains in close conformity with the animal's torso surface.

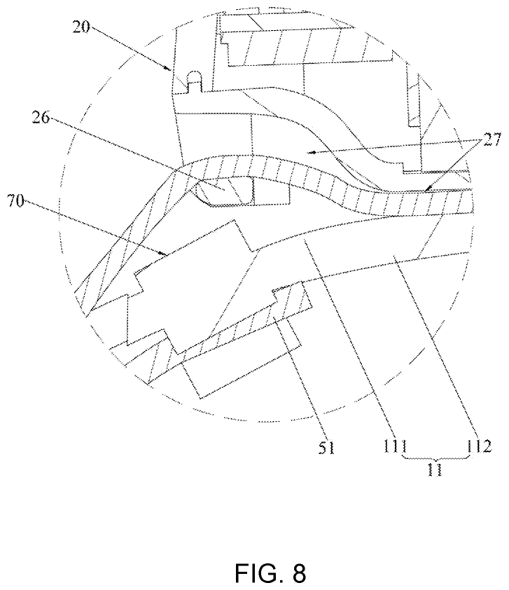

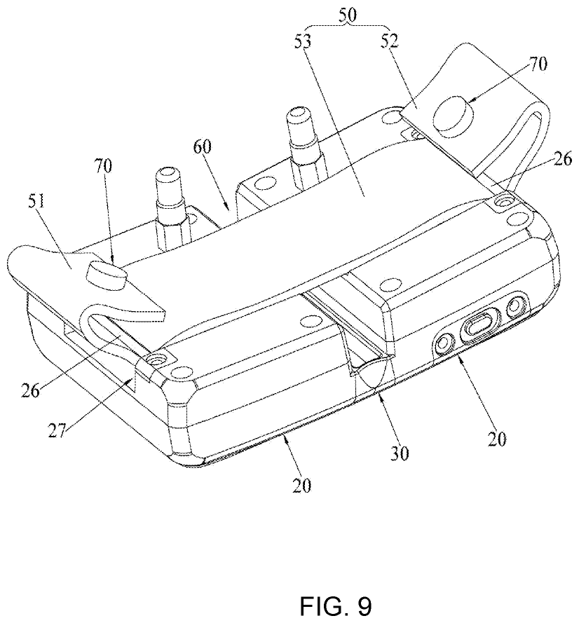

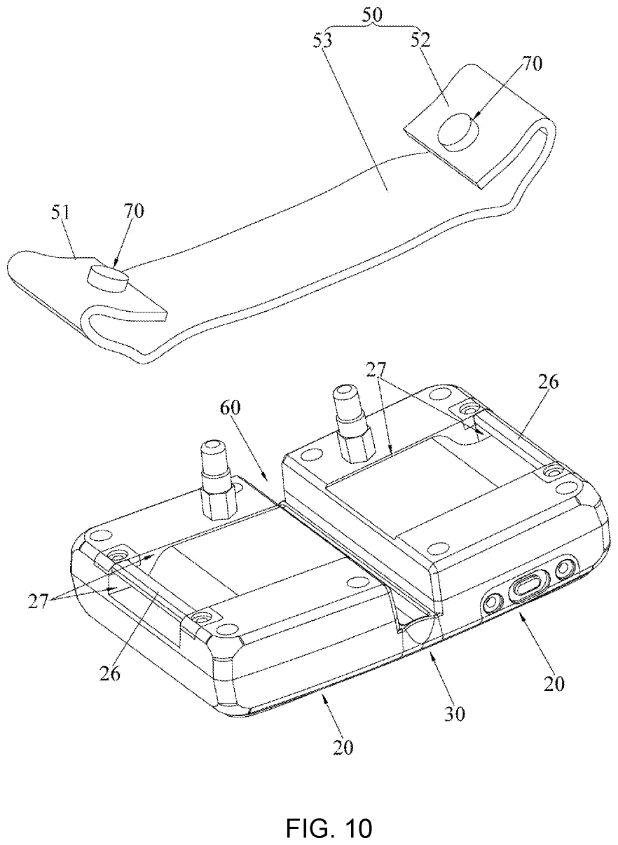

Specifically, as shown in FIGS. 8 to 10, in an exemplary configuration, each functional assembly 20 further defines a guide groove 27 facing the back portion 11 for guiding the functional assembly 20 to slide along the flexible connecting strap 50 during angular change. The portion 53 of the flexible connecting strap 50 between the first end 51 and the second end 52 is received in the guide groove 27 (see FIG. 8 or 9). The loop-around structure 26 extends across the guide groove 27 and is located at an end of the functional assembly 20 remote from the flexible connecting portion 30. For example, in FIG. 10, the left loop-around structure 26 is located at the left end of the left functional assembly 20, and the right loop-around structure 26 is located at the right end of the right functional assembly 20. By virtue of the configuration in which the loop-around structure 26 extends across the guide groove 27 and is located at the end of the functional assembly 20 remote from the flexible connecting portion 30, and the portion 53 of the flexible connecting strap 50 between the first end 51 and the second end 52 is received in the guide groove 27, the flexible connecting strap 50 more reliably connects the functional assemblies 20 to the back portion 11 and effectively restricts the functional assemblies 20 to sliding only along the flexible connecting strap 50 during angular change.

As shown in FIGS. 5, 6, 7, 9, and 10, in an exemplary configuration, in adjacent functional assemblies 20, each functional assembly 20 protrudes toward the back portion 11 relative to the corresponding flexible connecting portion 30 (i.e., the flexible connecting portion 30 between two adjacent functional assemblies 20). As a result, the adjacent functional assemblies 20 and the corresponding flexible connecting portion 30 together define a recess 60. The recess 60 faces the portion 53 of the flexible connecting strap 50 between the first end 51 and the second end 52. This configuration allows the surfaces 22 of the adjacent functional assemblies 20 facing away from the back portion 11 of the flexible harness base 10 to be flush with a surface 33 of the flexible connecting portion 30 facing away from the back portion 11 of the flexible harness base 10, making the harness device 100 neater and more aesthetically pleasing. In addition, because the adjacent functional assemblies 20 and the corresponding flexible connecting portion 30 together define the recess 60, the flexible connecting portion 30 can more smoothly permit relative angular change between the adjacent functional assemblies 20.

As shown in FIGS. 2, 5, 6, 9, and 10, in an exemplary configuration, the first end 51 and the second end 52 of the flexible connecting strap 50 are each detachably attached to the inner side 112 of the back portion 11 via snap fasteners 70, thereby facilitating assembly and disassembly of the functional assemblies 20 to and from the back portion 11. Alternatively, the first end 51 and the second end 52 may be detachably attached to the inner side 112 of the back portion 11 via hook-and-loop fasteners, or at least one of the first end 51 and the second end 52 may be attached via a hook-and-loop fastener or a snap fastener 70. Thus, the illustrated configuration is not limiting.

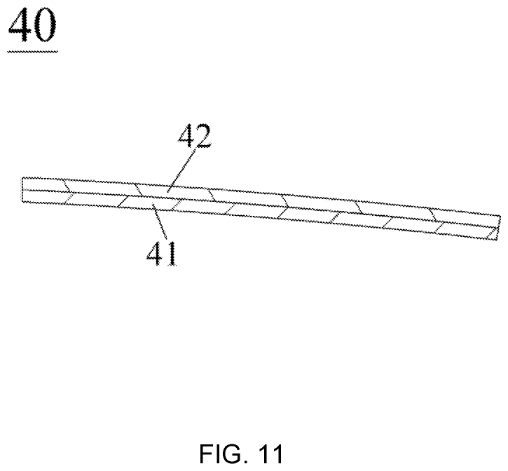

As shown in FIG. 11, in an exemplary configuration, the solar cell 40 further includes a perovskite solar cell 42 stacked on the gallium arsenide solar cell 41, so that the solar cell 40 forms a tandem cell structure of gallium arsenide and perovskite. This configuration provides higher unit-area output power within the limited light-receiving area, allowing the harvested solar energy to more effectively participate in the energy supply system of the harness device 100 and further improving the endurance of the device. Specifically, as an exemplary configuration, the tandem cell structure employs a two-terminal (2T) electrical connection, i.e., multiple sub-cell layers are connected in series electrically, to obtain a higher output voltage and improve unit-area output power. Alternatively, the tandem cell structure may employ a four-terminal (4T) electrical connection, i.e., different sub-cell layers output independently, and are combined, voltage-regulated, and/or charge-managed through the circuit assembly 21 or an energy management circuit, to improve energy harvesting under different spectral and light-receiving conditions. It should be noted that the solar cell 40 may optionally include the perovskite solar cell 42 stacked on the gallium arsenide solar cell 41 depending on actual needs. That is, in some embodiments, the solar cell 40 may be configured without the perovskite solar cell 42.

Compared with the prior art, the flexible harness base 10 has the back portion 11 that faces upward in the worn state, the chest portion 12 that faces downward in the worn state, and the front and rear side portions 13, 14 each connecting the chest portion 12 and the back portion 11, and the rear side portions 14, the front side portions 13, the back portion 11, and the chest portion 12 together define the side openings 15, the rear side portions 14, the back portion 11, and the chest portion 12 together define the rear opening 16, and the front side portions 13, the back portion 11, and the chest portion 12 together define the front opening 17, thus the functional assemblies 20 and the solar cells 40 thereon are maintained in an upward-facing orientation in the worn state, thereby providing stable light-receiving conditions, increasing the effective operating time ratio of the solar cells 40, and enhancing the availability and practical value of solar energy supply in the worn state. Furthermore, the solar cell 40 includes the gallium arsenide solar cell 41, thus higher unit-area output power is provided within the limited light-receiving area, allowing the harvested energy to more effectively participate in the energy supply system of the harness device 100, thereby improving the endurance of the device. In addition, by virtue of the flexible connecting portion 30, the adjacent functional assemblies 20 are allowed to undergo angular change in the worn state to adapt to curvature changes of the animal's body surface, thereby providing good wearing comfort and avoiding stress concentration.

It is noted that the flexible harness base 10 may be made of fabric. Although the drawings show two functional assemblies 20, the number of functional assemblies 20 may be three, four, or more, so the illustrated number is not limiting. In addition, although the drawings show each functional assembly 20 provided with a solar cell 40, it is also possible that only some of the functional assemblies 20 are provided with solar cells 40, so the illustrated configuration is not limiting.

The above disclosure is only preferred embodiments of the present disclosure and shall not be used to limit the scope of rights of the present disclosure. Accordingly, equivalent variations made in accordance with the claims of the present disclosure shall fall within the scope of the present disclosure.

What is claimed is:

1. A harness device for an animal, comprising:
a flexible harness base configured to be worn on a torso surface of the animal, the flexible harness base having a back portion that faces upward in a worn state, a chest portion that faces downward in the worn state, and front and rear side portions each connecting the chest portion and the back portion; the rear side portions, the front side portions, the back portion, and the chest portion together defining side openings through which the animal's front legs extend out of the flexible harness base; the rear side portions, the back portion, and the chest portion together defining a rear opening through which the animal's torso extends rearwardly out of the flexible harness base; and the front side portions, the back portion, and the chest portion together defining a front opening through which the animal's torso extends forwardly out of the flexible harness base;
at least two functional assemblies mounted on the back portion and facing an outer side of the back portion, each of the functional assemblies having a circuit assembly disposed therein;
a flexible connecting portion disposed between adjacent functional assemblies, the flexible connecting portion allowing the adjacent functional assemblies to undergo relative angular change in the worn state to adapt to curvature changes of the animal's body surface; and
a solar cell disposed on a surface of each functional assembly facing away from the back portion for powering the circuit assembly, the solar cell comprising a gallium arsenide solar cell.

2. The harness device according to claim 1, wherein the solar cell further comprises a perovskite solar cell stacked on the gallium arsenide solar cell.

3. The harness device according to claim 1, wherein the gallium arsenide solar cell is a multi-junction gallium arsenide solar cell.

4. The harness device according to claim 1, wherein the flexible harness base further comprises an opening/closing structure for separating or joining at least one of the front side portions and the rear side portions.

5. The harness device according to claim 4, wherein the opening/closing structure is a snap fastener or a hook-and-loop fastener.

6. The harness device according to claim 1, wherein the flexible connecting portion is an elastomeric connecting member, a flexible sheet-like connecting member, a corrugated connecting member, a serpentine connecting member, or a fabric composite connecting member, and the flexible connecting portion allows the adjacent functional assemblies to rotate relative to each other.

7. The harness device according to claim 1, wherein an end of each functional assembly is provided with an end connection interface structure for cooperating with the flexible connecting portion, the end connection interface structure being connected to the flexible connecting portion by overmolding, snap-fitting, or interlocking.

8. The harness device according to claim 7, wherein each functional assembly defines a communication channel therein, and the flexible connecting portion defines an electrical connection channel therein aligned and communicating with the communication channel; a conductive member is disposed within the electrical connection channel for electrically connecting the circuit assemblies of the adjacent functional assemblies; and the conductive member is an electrical wire or a flexible printed circuit board.

9. The harness device according to claim 8, wherein the end connection interface structure includes an annular boss disposed around the communication channel and overmolded with the flexible connecting portion.

10. The harness device according to claim 9, wherein a sidewall of the annular boss defines an annular groove extending circumferentially around the annular boss and overmolded with the flexible connecting portion.

11. The harness device according to claim 1, wherein at least one of the functional assemblies further has an energy storage unit disposed therein for storing electricity supplied by the solar cell.

12. The harness device according to claim 1, wherein the circuit assembly includes a positioning module and/or a wireless communication module.

13. The harness device according to claim 12, wherein the wireless communication module includes at least one of cellular communication, Bluetooth, and Wi-Fi communication.

14. The harness device according to claim 1, further comprising a flexible connecting strap disposed between the back portion and the functional assemblies, wherein the back portion defines a first through hole and a second through hole; a first end of the flexible connecting strap passes through the first through hole and is attached to an inner side of the back portion, and a second end of the flexible connecting strap passes through the second through hole and is attached to the inner side of the back portion.

15. The harness device according to claim 14, wherein each functional assembly is provided with a loop-around structure around which a portion of the flexible connecting strap between the first and second ends loops to mount each functional assembly onto the back portion.

16. The harness device according to claim 15, wherein each functional assembly further defines a guide groove facing the back portion for guiding the functional assembly to slide along the flexible connecting strap during angular change, the portion of the flexible connecting strap between the first and second ends being received in the guide groove.

17. The harness device according to claim 16, wherein the loop-around structure extends across the guide groove and is located at an end of the functional assembly remote from the flexible connecting portion.

18. The harness device according to claim 14, wherein, in the adjacent functional assemblies, each functional assembly protrudes toward the back portion relative to the corresponding flexible connecting portion such that the adjacent functional assemblies and the corresponding flexible connecting portion together define a recess, the recess facing the portion of the flexible connecting strap between the first and second ends.

19. The harness device according to claim 14, wherein at least one of the first end and the second end of the flexible connecting strap is detachably attached to the inner side of the back portion via a hook-and-loop fastener or a snap fastener.
